(19) United States
(12) Patent Application Publication
(10) Pub. No.: US 2007/0100942 A1
(43) Pub. Date: May 3, 2007

(54) Method and system for multimedia message service communication

(76) Inventors: Hong Lin, Beijing (CN); Song Song, Beijing (CN); Pei Sun, Beijing (CN); Jun Shen, Beijing (CN)

Correspondence Address: LOUIS PAUL HERZBERG, 3 CLOVERDALE LANE, MONSEY, NY, 10952, US

(21) Appl. No.: 10/558,547

(22) PCT Filed: May 25, 2004
(86) PCT No.: PCT/EP04/50874

§ 371 Date: Oct. 23, 2006

(30) Foreign Application Priority Data
May 29, 2003 (CN) 03138197.9

(51) Int. Cl. G06F 15/16

(52) U.S. Cl. 709/206

(57) ABSTRACT

An interactive method, a user terminal and a communication system am provided for multimedia message services. The method comprises the steps of receiving a multimedia message from a server; generating a page displaying or playing the multimedia message at a user terminal, wherein one or more controllers are embedded into the displayed or played multimedia message and associations between said controllers are defined; and triggering at least one action event and performing a corresponding action in response to the operations of one or more controllers. A response message fed back to the server is automatically generated at the user terminal, and an optimized multimedia message interface is provided for the user, a local interaction and a interaction between the terminal and the back end service can be flexibly realized.

### TECHNICAL FIELD

The present invention generally relates to the communication technology, and in particular to an interactive method, a user terminal and a communication system used for multimedia message services.

### BACKGROUND

As an attractive value-added service, the short message service (SMS) is increasingly becoming another important service area in mobile communication networks involved voice service as a leading function. A wide range of different value-added data services are based on this kind of mobile data communication means of short message such as mobile phone bank, mobile phone securities, information on-demand, wireless e-mail, wireless data communication and fax etc. All these are referred to as “short message service” (or SMS) in general.

At present, SMS is a fairly basic data service that enables a wireless subscriber to send simple text messages of up to 160 characters at the present. SMS has, as a insult of the development in communication, been developed from a simple notification means to a versatile platform for value-added services.

Taking FIG. 1 for example, where a conventional solution is shown for SMS based value-added services adopted for wireless subscribers. For example, if a user wants to ask for a current stock quote of IBM via SMS, he or she has to find the IBM stock quote service code (SQ) and the service provider access number (i.e. message center number, e.g. 123456), and input the command format (i.e. the service code plus the company name: SQ IBM), then sends this to a message center to request the desired information about the stock quote of IBM. Upon receiving a request from a subscriber, the message center (or network server) provides the content requested by the subscriber in response. Although it is very troublesome to remember and input the contents relating to this kind of requests, the SMS based value-added service gives users the convenience to access and to acquire information.

Because the current short message service supports mainly relatively short texts, the future development in contents of the short messages will be focused on multimedia contents. The most prominent feature of this kind of richer short message service, however, is to support multimedia messages to pass on video clips, pictures, audio samples and text. Multimedia message service (MMS) has been proposed in consequence of the technical upgrades in the short message service.

MMS is the natural evolution of SMS. The messaging standard for MMS is set up by two organizations, WAP (Wireless Application Protocol) Forum and 3GPP (3^{rd} Generation Partnership Project). Therefore MMS is designed to operate at upper levels of the WAP protocol, without limitation to a certain art of transmission, supporting both the circuit switched data communication and the general packed radio service (GPRS) data communication. MMS currently adopts WAP-push technique, which is a store & transmit function similar to that of SMS, and therefore the current MMS technique remains yet a store/transmit one. This means that if a message is sent by a handset, a recipient will not receive it directly. Instead of that, the message is received in advance by a multimedia message center of the network in which the subscriber resides, and then the multimedia message center sends a notification to the recipient informing that the recipient should download the message from the multimedia message center. A similar multimedia message center exists also in SMS systems, but as all the messages to be sent are text ones, it is relatively simple in operation. Whereas by MMS, the operation in the message center is relatively complex as it will not rely on a certain network of a certain operator, so if, for example, the recipient resides on a slower network, or his/her handset's screen has a different size, the equipment at the operator needs to be able to detect the situations and to configure a corresponding message format.

MMS is a new global message communication standard, the most prominent feature of which is the supporting of multimedia applications. The multimedia message enables contents and pieces of information with a full range of functions, including images, audio information, video information, data and text, to be transferred, and video clips, pictures, voice and text, supported by a GPRS network, to be transferred, by taking advantage of WAP protocol as a carrier. When the MMS specification was constituted by the standard organization it was once conceived that MMS should be an applications bearing platform serving not only as a store-forward center for messages but performing various enriched applications. Through a mobile terminal supported by MMS a user should enjoy the same content services and experiences, as he or she would get through the classical Internet. As MMS can support a wide range of data format standards, such as image format, audio format, animation format standard, that entirely the same experience as get from the internet is therefor desired to be available for user by MMS, or even multimedia data stream support is expected, when, in future band width allows this, to greatly enhance the message expression capability and enrich message contents. MMS promises a dramatic increase in messaging capabilities that will enrich user experience and create a major new source of revenue for network operators as well as content and service providers. However, a primary shortcoming or imperfection of the current MMS standard is that MMS is still in a situation of “simple communication”, that is to say, most of the short message services available at present are unidirectional, generally do not provide interaction between content sources or providers and end users. Although some features of interaction between end users and servers (or content and/or service providers) have been proposed, involved only in those features that a mobile subscriber send a message with a mobile terminal to reply a information request, which do not satisfy real time demands for information interaction from users, and this fact limits the development of the value-added MMS services.

MMS is the natural evolution of SMS. Because MMS delivers much richer content than SMS, MMS provides a friendly and vivid method for expression. However, the service model inherits from the MMS, and users have to compile the request message by themselves. And currently most of MMS applications only focus on how to transmit and present images, ring tones and text, but do not talk about how to make full use of MMS characteristics to enhance the user experience in MMS value added services. Especially in most of MMS applications, attention is scarcely paid to provide or improve interaction services between end users and servers (e.g. MMS providing servers) and to aim at a MMS available on a server, and a more meaningful local interaction at users mobile terminal is impossible. For example, an associated operation on individual information items in a received multimedia message is not realizable. The contents of multimedia message that can be displayed on a user terminal are limited and, the user needs either by repeating many times of operations or operating on the message displayed to get a further information, or by compiling request message and sending the message thus composed to the server to get more information. Needless to say, it is not only that the message contents that a user can get are limited, but that the procedure a user must take is boring and troublesome, all of these reduce the experiences a user get in multimedia messages.

As it is shown in FIG. 2, where a MMS structure is simply illustrated, a multimedia message consists of MMS headers and a message body. The MMS headers contain such information on how to transfer the multimedia message from an original to a recipient, as an original address, destination address and etc. The message body consists of several parts including multimedia objects, such as image (jpeg format), text (plain format), audio (way format), each in separate part, as well as the optional presentation part. The presentation part contains instructions to explain how the multimedia content should be rendered. In the prior at there are various alternatives of the computer presentation language, which deals with how to display presentations.

One of the presentation languages mostly used by those skilled in the art is Synchronized Multimedia Integration Language (SMIL). SMIL is a common deployment for MMS presentation. It is an important way to integrate multimedia into a Web content. SMIL is an extendible markup language (XML) based language. The XML language allows to describe timing indicated by multimedia, to associate supper-links with multimedia objects and to define the layout presented on the screen. SMIL is regarded as a way for enriching of the current text message based transmission technologies. SMIL consists of a set of modules that define the semantics and syntax for certain areas of functionality. These modules are layout module, timing and synchronization module and animation module. SMIL merely describes how to show a message on a screen, but it does not provide any interactive features for end users. So the SMIL needs to be extended to support interactive presentation, because interactive messages can provide good user experience to popularize the MMS technology to wider application areas.

Another presentation language mostly used by those skilled in the art is Hypertext Markup Language (HTML). The HTML is the most popular language supporting interactive presentation in Web applications. But the HTML form (a form presenting as a HTML document) cannot be used in MMS, because the HTML form cannot separate the content from the presentation, in other words, in a HTML form the presentation is often mixed with the data. As matter of fact, there are so many MMS clients with quite different capabilities, and the separation between the content and the presentation would make it possible to support different MMS clients. This is a basic requirement for a MMS message presentation language. Furthermore, the protocol adopted in the network service program, for example the communication model of Hypertext Markup Language (HTML), is request/response. This model leads to more round trips between the service and the client's mobile terminal. MMS is a message system, which runs over wide-area wireless network. It is not a real-time message. If the request/response model could be implemented, the round-trip will bring huge latency and reduce the performance of the whole system. What is needed is to display a richer dynamic form in an optimum way on a MMS client's terminal.

### DISCLOSURE OF THE INVENTION

In view of the above problems in the prior art the aim of the present invention therefore is to provide an interactive method for multimedia message services.

An object of one or more embodiments of the present invention is to realize an interactive multimedia communication between subscribers and a MMS back end system, for example a multimedia message providing server, preferably in response to an piece of multimedia message from a server a response message is generated automatically to be sent back to the server without a multiple round-trips between the user terminal and the server, and according to the present invention a flexible, richer and more convenient local interaction at user terminal is possible.

Another object of one or more embodiments of the present invention is to provide an optimized user interface of the MMS message for users. To this end one or more interactive controllers are embedded into the multimedia message, the user performs the local interaction of the user terminal as well as the interaction between the user terminal and the server (for example a multimedia message sending server).

Yet another object of an embodiment of the present invention is to create a dynamic Web form, which is displayed on the user terminal, in XForms language, preferably a plurality of dynamic forms included in an single message presenting page to provide richer interactive presentations and more optimized multimedia messages for the user, to enhance his or her experience.

According to the present invention an interactive method for multimedia message services is provided, comprising steps of receiving a multimedia message from a server, generating a page displaying or playing the multimedia message at a user terminal, wherein one or more controllers are embedded into the displayed or played multimedia message and associations between said controllers are defined; and triggering at least one action event and performing a corresponding action in response to the operations of one or more controllers.

In one embodiment, said triggered action event is to send back a response message to the server which renders said multimedia message; and in response to the operation of said controllers, automatically generating a response message for request to submit an order.

In another embodiment, said triggered action event is to modify the content of said multimedia message; and in response to the operation of said controllers, displaying or playing said modified content of said multimedia message.

In another embodiment, the step of generating the page for displaying or playing a multimedia message further includes: parsing the received multimedia message to obtain the presentation structure of said multimedia message; and generating a data model used in the page for displaying or playing said multimedia messages based on said multimedia message presentation structure.

According to another aspect of the present invention, a user terminal for multimedia message service is provided, adopted to receive multimedia message from a server and process said multimedia message, said user terminal comprises: a device for receiving multimedia message from a server, a device for generating a page for displaying or playing said multimedia message; a device for embedding one or more controllers, between which relationships are defined, into said displayed or played multimedia message; and a device for triggering at least one action event in response to an operation of said one or more controllers, and for implementing the corresponding action.

According to yet another aspect of the present invention, a communication system for multimedia message service is provide, said system comprising: one or more user terminals; one or more servers for sending a multimedia message to said user terminals, characterized in that said user terminal comprises: a device for receiving a multimedia message from a server, a device for generating a page for displaying or playing said multimedia message; a device for embedding one or more controllers, between which relationships are defined, into said displayed or played multimedia message; and a device for triggering at least one action event in response to an operation of said one or more controllers, and for performing the corresponding action.

The interactive approach for the multimedia message service according to the present invention, the user terminal and corresponding communication system as well as the corresponding computer program provide a method for generating the value-added message based message for multimedia message providers, a friendly user interface, which enables a more vivid dynamic form to be presented in an optimum manner, for the MMS user, and a more convenient way to send a service request for the MMS user. According to the present invention the user can access more information while the round-trips between the server and the user mobile terminal are reduced without taking up too many system resources or causing latency. According to the present method, the performance of the message service system is improved.

### BRIEF DESCRIPTION OF THE DRAWINGS

Embodiments of the invention will now be described, by way of example only, and with inference to the following drawings:

FIG. 1 schematically shows a SMS interface presented on a user terminal;

FIG. 2 schematically shows the message structure of conventional multimedia message;

FIG. 3 schematically shows a block diagram of a MMS communication system employing the method of an embodiment of the present invention;

FIG. 4 schematically shows the interactive procedure for the multimedia message service according to an embodiment of the present invention;

FIG. 5 schematically shows the flow chart of the procedures of the interactive method for the multimedia message service according to an embodiment of the present invention;

FIG. 6 shows logic models of the interactive controller according to an embodiment of the present invention;

FIG. 7 shows one of the controllers according to an embodiment of the present invention;

FIG. 8 schematically shows an example of the interactive multimedia message service implemented according to an embodiment of the present invention;

FIG. 9 schematically shows a data model of the multimedia message according to an embodiment of the present invention;

FIG. 10 schematically shows a data model of an exemplary multimedia message illustrated in a method for realizing the interactive approach for multimedia message service; and

FIG. 11 schematically shows a functional diagram illustrating an middleware process according to the present method.

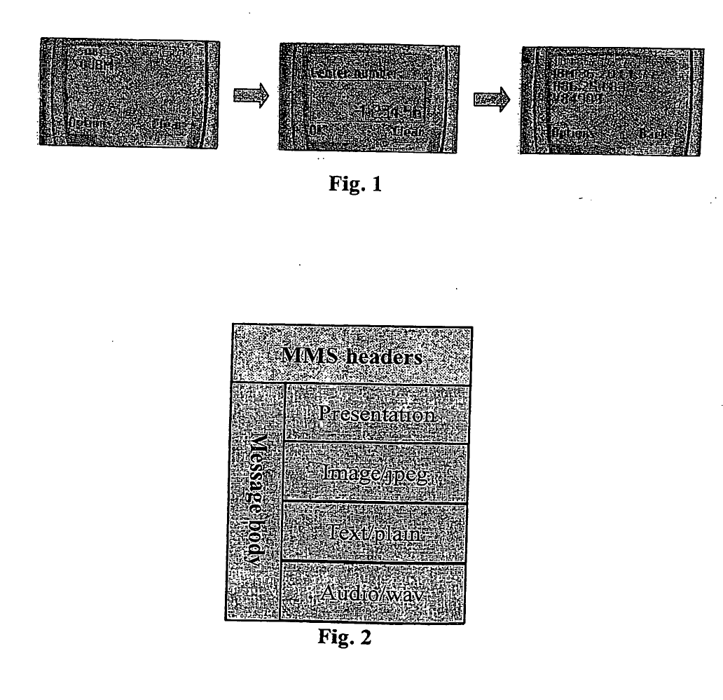

### MODE(S) FOR CARRYING OUT THE INVENTION

Hereafter a detailed description will be given to embodiments of the present invention with reference to accompanying drawings. It should be understood that the following description enables those skilled in the art to carry out present invention. Various changes and modifications will become apparent to those skilled in the art, and the teachings of the present invention can be applied to other embodiments. The present invention is therefore not intended to be limited to the exemplary embodiments described below.

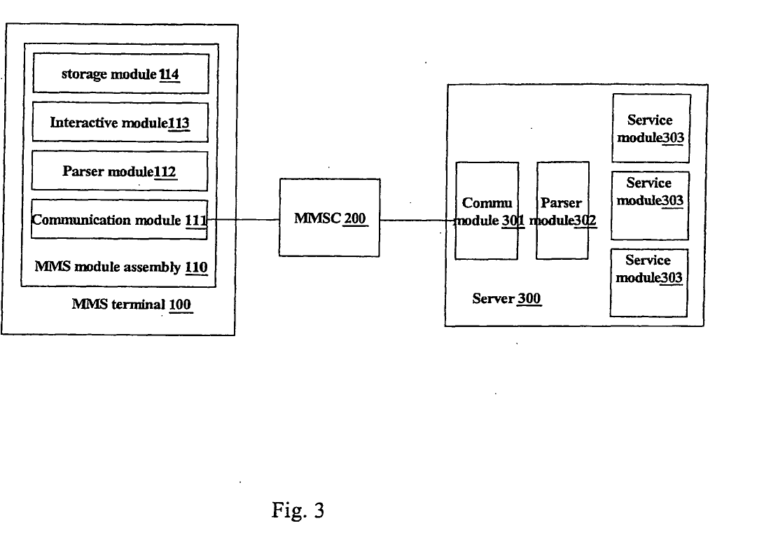

Reference is now taken to FIG. 3 which schematically shows a block diagram of a MMS communication system. The MMS communication system is adopted to activate the interactive multimedia message, realizing communication between a user mobile terminal and a server, for example a multimedia massage server. A MMS communication system generally comprises of three main parts: a MMS value-added service server 300, a communication network and MMS center (MMSC) 200, and one or more MMS terminals 100. The value-added service server 300 provides and sends multimedia message, and can receive request in message form from the MMS terminal 100. Preferably MMS value-added service serve 300 may comprise a communication module 301, a message parser module 302, and one or more service module 303. The communication module 301 is adopted to process various possible communication protocols, for example HTTP or SMTP. The message parser module 302 parses incoming request message, for example, from the MMS terminal 100 to derive the format and content of message to be presented, according to the association information contained in the message header, from the received message, and then passes the request message to a corresponding service modules 303. The service modules 303 are used to process the service logic. The communication network and MMSC 200 can be provided by suitable communication operator. The MMS terminal 100 may be any communication device, which allows multimedia message communication, either an individual multimedia communication device or various other communication devices which have the capability of carrying out multimedia message communication, and the corresponding hardware structure, the MMS terminal includes but is not limited to a mobile telephone, a personal digital assistant (PDA) and etc. In general, the MMS terminal 100 comprises a MMS module 110 for carrying out the multimedia user application program on the MMS terminal 100. Through running the multimedia user application program on the MMS terminal 100, the local interaction on the MMS terminal 100 and the interaction between MMS terminal 100 and the server 300 are realized. Preferably, the MMS terminal 100 includes at least four components: a communication module 111, a parser module 112; an interactive module 113, and a storage module 114. Wherein the communication module 111 mainly process various MMS communication protocols so as to communicate with the server 300 via the MMSC 200. The parser module 112 parses the multimedia message received from the saver, reads out the information in respect to the message format to be presented on the MMS terminal 100 and the related information, so as to carry out corresponding process on the message of various presentation format. Should, for example the received message format be pictorial a picture information is displayed according to the picture message format; an audio one, an audio message is played; and a textual one, the content of a text is displayed. The interactive module 113 carries out the associated operations corresponding with individual controllers listed in the multimedia message form, according to the relationship between the media objects, which have been parsed from the received multimedia message, to realize the local interaction on the MMS terminal 100 and the interaction between MMS terminal 100 and the server 300. The storage module 114 is used to store the received message and involved process results therewith.

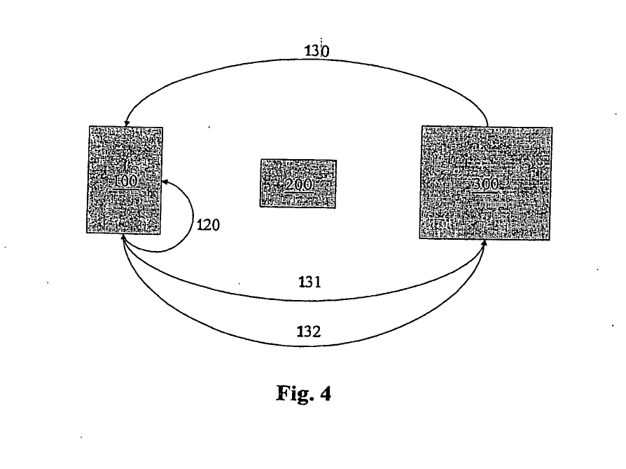

Now reference is taken to FIG. 4. FIG. 4 schematically shows the interactive procedure for the multimedia message service according to an embodiment of the present invention. Firstly, in procedure 130 the server 300 sends an interactive multimedia message to the MMS terminal 100 via a communication network and a MMSC 200. The message is, for example, sent once and may be permanently stored into the MMS terminal 100.

In procedure 120, a process of a local interaction on the MMS terminal 100 is shown. The local interaction process is a process that deals mainly with user operations, namely that the user performs operations, including adding, deleting, modifying, entering, selecting, searching and etc., on various forms provided on the user interface. Of course the user can either choose one or more from said operations, or perform none of them.

Depending on the requirement, an interaction between a MMS terminal and a server is also realizable. In procedure 131, a request message comprising request message inputted or chosen by the user, is sent from MMS terminals 100 to service server. Preferably, a response message with the desired service is sent back (procedure 132) to the server 300.

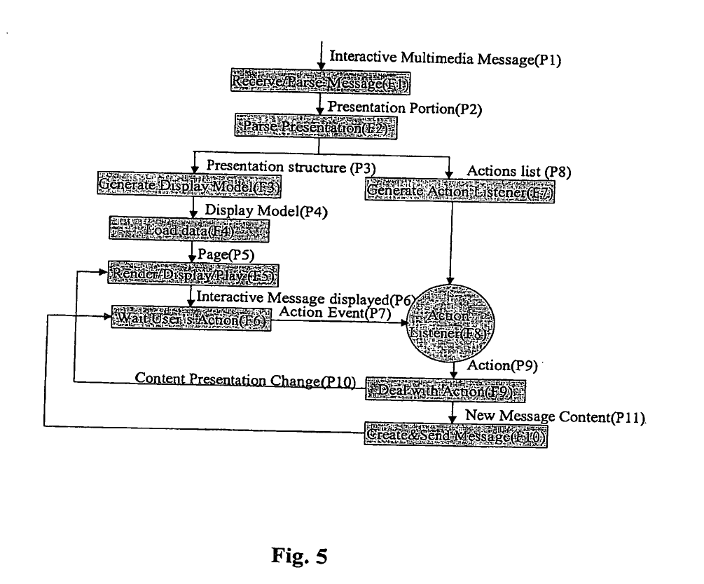

Hereafter, the interactive approach for multimedia message service is further explained in details with reference to FIG. 5.

FIG. 5 schematically shows the flow chart of the procedures of the interactive approach for the multimedia message service of an embodiment of the present invention. The procedure steps illustrated in the flow chart are mainly performed through a MMS module assembly 110 in the above-mentioned MMS terminal 100, that is that the present embodiment is realized through performing the user application program, which runs on the MMS module assembly 110, in the communication module 111, the parser module 112 and the interactive module 113. Of course the description of the embodiment is only given in an illustrative manner, and the present invention is not limited to the structures shown in the accompanying drawings.

Now reference is taken to FIG. 5. In view of the multimedia message (P1) from the multimedia message server 300, in step F2, the multimedia message is received by the MMS terminal 100 via MMSC200. Firstly, parser module 112 parses the presentation portion (P2) of the message out of the received message data. The presentation portion (P2) is frequently involved in the message content to be presented. Next, in connection with the presentation portion (P2) of the message, the presentation portion is further parsed in step F2, that is, an analysis is carried out in respect of the description about how to display the message. The presentation structure (P3) of the presented message, acquired therefrom, is the related message format to be presented on the MMS terminal. Besides, while parsing of the presentation portion of the message is carried out, the rules of relationship and activities between controllers is parsed and then the relationship and activities are embedded in an action form (P8). Based on the parsed presentation structure (P3), in step F3, a data model (P4) of the presentation message or display message is created according to different message formats, such as a text format, an audio format, or a message format, which is preferably displayed in a Markup language. In view of the created data model (P4) for displaying or playing message, corresponding data are loaded and a message page (P5) is created in step F4. In step F5, the created message page is displayed or played on the MMS terminal 100. In view of the presented multimedia message the user performs operation on it, and in step F6 in response to a user operation an action event (P7) is created. And in step F8, an action listener is used to monitor the action event (P7), the action event is processed and a corresponding action is generated. The action listener is, in step 7, generated based on an action list defined for regulation regulations, resulted from the parsing of the presentation portion performed in step 2. In step 9, in view of the action (P7) monitored in step F8, an event-processing program is activated to process the user's action. The monitored actions are, for example, divided into two kinds, one is to change the contents (P10) on the message page on the MMS terminal. For this kind of action, step F5 is repeated, that is, the action is processed on the basis of the action rules defined in the action list, so as to display or play the changed message page on the MMS terminal 100. The other is involved in the interaction with the service, in step F10, on the basis of the new message model and the related data, if the event is an event involved in message delivery, a message is generated in accordance with the message model and the user's preference and then the generated message is sent to server 300.

According to an embodiment of the present invention, when the MMS presentation model is created one or more interactive controllers are provided on a multimedia message presentation interface in which number of forms are provided. The interactive controllers may be an submit button for an order form, a radio button, a check box, a text, a text field, a list box, an option menu and etc. Each of the controllers can be designated a name. When a form is submitted, the name and current value of a specific controller can be sent together with the form. By embedding controllers into the multimedia message, the user can express his or her preference to the service application program by means of these interactive controllers, to provide an interactive solution.

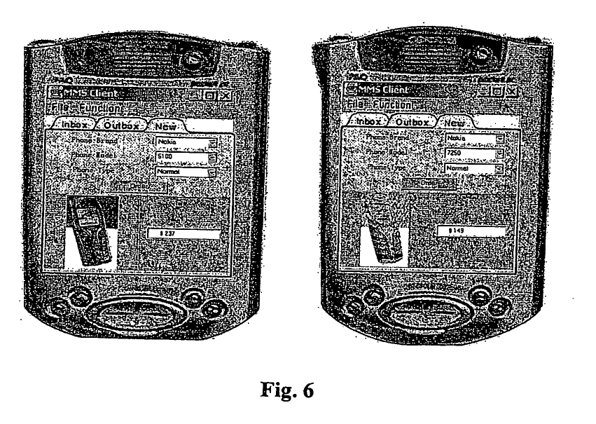

Now the reference is made to FIG. 6, which shows logic modules of the interactive controllers according to an embodiment of the present invention.

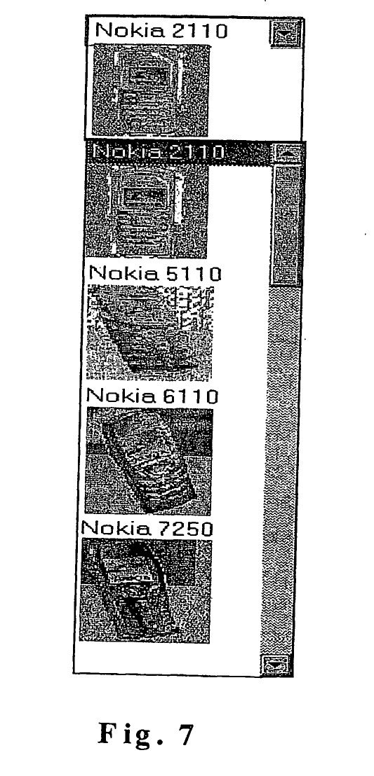

The present embodiment supports multimedia items throughout extending interactive controllers. The supported multimedia items may be image, audio and video. The items of the radio button, the check box, the list box and the option menu maybe pictures, audio and video clips. Taken the option menu for example, the items of the option menu could be pictures. Each picture represents an item. Take the multimedia options menu shown in FIG. 7 as an example. In FIG. 7 models of Nokia handsets, for example Nokia2110, Nokia5110, Nokia6110, Nokia7250 etc and pictures of the respective models of handsets are illustrated. The user can, for example, click a handset picture for one of the various models, and the handset of this model is displayed on the display screen of the user terminal, MMS terminal 100. The user can also move the slide box to display more Nokia models of handsets and pictures.

Hereafter descriptions will be given to the relationship between the interactive controllers proposed by an embodiment of the present invention. Logic modules are adopted to define relationships and actions. The relationship between the interactive controllers includes two kinds of relationships, namely LINK and CONTAIN. For example, if a LINK relationship exists between two or more interactive controllers, when one of the controller items is selected, all of others are selected too. Consequently, when one of the controller items is displayed, all of others are displayed or played too. As it is shown in FIG. 6, when the model of a handset is changed from Nokia 5100 to Nokia7250, for every model of handsets their pictures and prices are changed in consequent respectively. CONTAIN is another relationship. For example, if the item 1 of the controller A contains items 1 through 7 of the controller B, when item 1 of the controller A is selected, only items 1 through 7 of the controller B can be selected.

According to an embodiment of the present invention, firstly the existing MMS system is extended to display a richer dynamic form on the user terminal wherein the displayed individual controller have certain association, preferably the relationship between controllers are defined as LINK relations or CONTAIN relations, to facilitate the user to operate on the displayed multimedia message, such that a convenient means for the interaction between the subscriber and the back end systems is provided. A user can select and input his or her preference by means of these interactive controllers, and the interactive controllers designed according to the present invention can automatically generate a response message based on the user's choice. The user pushes the order form submit button, and a response message is generated and sent out. For example, a response message, which contains an order request i.e. an order form, is generated automatically, and sent to the server. A common solution is provided to message servers/users to generate/operate on value added services by means of extending the MMS system. A very friendly user interface of the MMS message is provided to the user by means of using these interactive controllers. When the user selects different parameters, the message is displayed with a different presentation structure. In this manner, the user can accomplish a local interaction or an interaction with a message server.

The extending of the existing MMS system according to an embodiment of the present invention is realized by embedding XForms technology into MMS presentation language. The current MMS standard is extended to enhance the interaction capability for the MMS message. The XForms is extended to support the multimedia interactive controllers. The relationship between the controllers is described by means of a XML based document. For example, the relation description is named Relationship XML (RXML). And a MMS middleware system is introduced to process the interactive multimedia message service.

XForms is an XML-based language, which defines form based interaction interfaces. XForms is a renewal of the HTML form composed in the HTML language. XForms provides an extendable method to contain richer and more dynamic forms in the HTML file. By splitting a conventional HTML form into three parts, namely data model, exemplary data and user interface. The presentation is separated from the content, so a multiplex is allowed and more powerful input function is available. XForms and XMIL are all XML based languages. XForms can be integrated into SMIL. XForms provides various kinds of interactive controllers including a submit button, a radio button, a check box, a text, a text field, a list box, an option menu and etc.

These interactive controllers are extended to support multimedia related objects. The present embodiment supports multimedia items through extending interactive controllers. The items of the radio button, the check box, the list box and the option menu may be pictures, audio and video clips. Taking the option menu for example, an item of the menu is a picture. Each picture represents an item.

The relationship between the interactive controllers is described in XML language. According to an embodiment of the present invention the relationships between the interactive controllers are defined as two kinds of relationships. They are LINK and CONTAIN relations. The most commonly used relation is the LINK relation. For example, if there is a LINK relationship between two or mole interactive controllers, when one of the controller items is selected all the other are selected too. Consequently, when one of the controller items is displayed all the rest items are displayed or played at the same time. CONTAIN means that, if the item 1 of the controller A comprises items 1 through 7 of the controller B, when item 1 of the controller A is selected, only items 1 through 7 of the controller B are selected.

Hereafter the relationships between the controllers are further explained by means of examples.

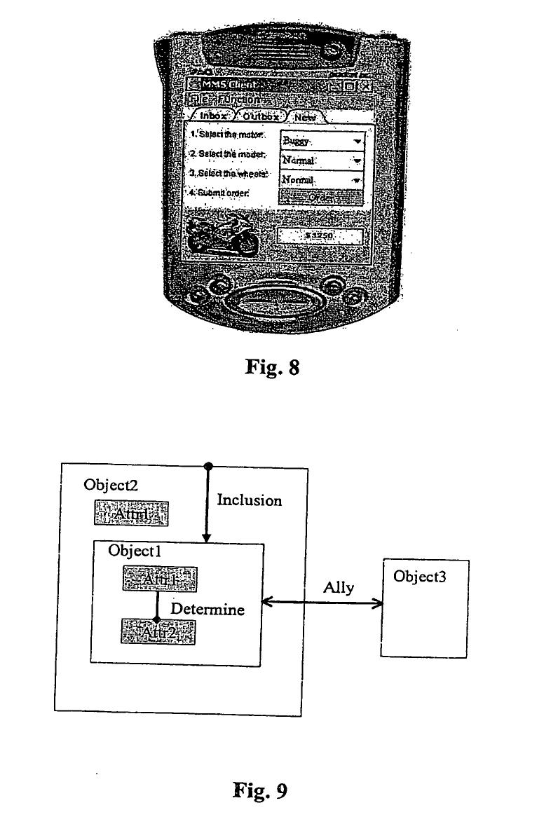

Taking motorcycle shopping for an example, when a user receives a motorcycle promotion message (refer to FIG. 8, motorcycle promotion interactive message) and is interested in buying one. The user can preview the pictures and prices (LINK relationship) of different kinds of motorcycles simultaneously by simple select from the model options menu. In other weds, as the user chooses a model of a motor the picture and the corresponding price are displayed in consequent. Furthermore, if a user wants to buy a model of motorcycle, a Buggy for example, what he needs is only to select the model and click the order form submit button (to submit an order form) as well.

FIG. 9 schematically shows a data model of an embodiment of the present invention. Wherein, the object 1 is included in the object 2. The object 1 and the object 3 have an ally relationship. The attribute of the object 1 define those of the object 2. If the object 1 is changed from one condition to another, for example the attribute 1 changes, the object 2 and 3 are changed in consequence.

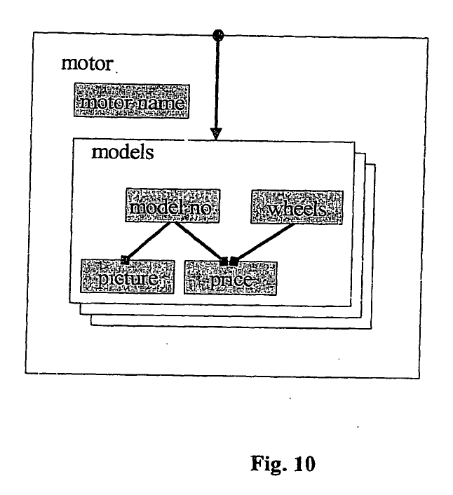

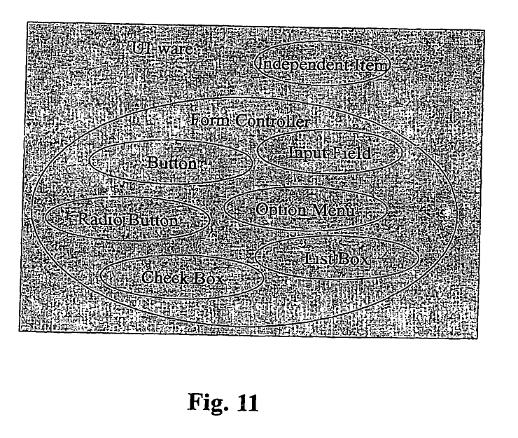

FIG. 10 schematically shows a data model of an example of motorcycle buying. In the portion of presentation structure, the data model of the message shows five options including motor, models, and types of the wheels, pictures, prices and order form submit buttons of bicycles. Generally, instance data gives actual data on the basis of a data model. Two pieces of message may have the same data model but different instance data. In FIG. 11, the instance data is information about motorcycle promotion. The user interface defines the position, format and size of the individual items.

Relationship or action portion describes the relationship between the object and the action at the time an event takes place. Usually a message comprises information about one or more objects no matter how to present the information. Relationship or action portion describes the internal relationship between data and the internal relationship between the attributes. For example, one attribute is defined by other attributes or other attributes are defined by one attribute. There are also external relationships between the objects.

For example, in the relationship/action portion, the relationship between motor, models, pictures, prices and types of the wheels of bicycles is shown in FIG. 10. Motorcycle types have a group of models; therefor motorcycle objects include model objects. When a type of motorcycle is selected, models that belong to this type can be presented in the type option menu of this type (CONTAIN relationship). Each motorcycle model correspondents to a respective picture. But there are some types of wheels available for users as options. When a user pushes the order form submit button, a response message is composed by the MMS client application. The response message is generated on the basis of the push action.

To provide a friendly interaction feature so as to enrich the user experience of the MMS value-added service, in an embodiment of the present invention, it is achieved by describing the service expression in extended XML language as following:

<?xml version=“1.0” encoding= “ISO-8859-1”?>
<smil xmlns= “http://www.w3.org/2001/SMIL20/Language”

xmlns: xfm= “http://www.w3.org/2002/01/xforms”>

<xfm: model id= “form1”>

<xfm: submitInfo id=“submit 1” method2= “postxml”localfile=
“temp.xml”
target2= http://www.ibm.com/motopromote/”/>
//attention A
<xfm: instance xmlns=“”>

<moto>

<moto></moto>
<model></model>
<wheel></wheel>

</moto>

</xfm:instance>

</xfm:model>
<body>

<par region=“preference”>

<xfm:optionmenu ref=“moto”>

<xfm: caption>1. Select the moto</xfm:caption>
<xfm:item>Buggy</xfm:item>

</xfm: option>
<xfm: optionmenu ref=“model”>

<xfm: caption>2.Select the model</xfm: caption>
<xfm: item>Normal</xfm:item>

<xfm: item>Model A</xfm:item>
<xfm: item> Model B</xfm:item>

</xfm: option>
<xfm: optionmenu ref=“wheel”>

<xfm: caption>3.Select the wheels</xfm: caption>
<xfm: item>Normal</xfm:item>
<xfm: item>Enhanced</xfm:item>

</xfm: option>

</par>
<par region=“submit”>

<xfm:submit name=“submit” ref=“moto” to=“submit1”>

<xfm: caption>Submit</xfm: caption>

</xfm: submit>

</par>
//the img region to display the motor picture
<par region=“imgRegion” dur= “indefinite”/>
//attention B
<xfm: optionmenu model=“ picture”
ref=“ picture”>

<xfm: caption> </xfm:caption>
<xfm: item>buggy.jpg</xfm:item>
<xfm: item> buggy_A.jpg </xfm: item>
<xfm: item> buggy_B.jpg </xfm: item>

</xfm: option>
<xfm: optionmenu ref=“price”>

<xfm: caption> </xfm: caption>
<xfm: item>$1250</xfm:item>
<xfm: item>$1350</xfm:item>
<xfm: item>$1399</xfm:item>

<xfm: option>

</par>
</body>

</smil>

The multimedia message service presentation uses SML and Xform to describe the message user interface. The interactive controllers are presented by XForms. When a MMS terminal client receives the message, the presentation is parsed and rendered to display the interactive motorcycle promotion message, which looks like FIG. 8. For example, the sentence “Attention A” shows a response message format. When a user pushes the submit button, a response message is composed by MMS client application. The response message is as following.

<?xml version=“1.0” encoding= “ISO-8859-1”?>

<moto>

<moto>Buggy</moto>
<model>Normal</model>
<wheel> Normal </wheel>

</moto>

</xml>

In addition, the important feature of the application is the multimedia option menu, which shows the picture of the motors. The attention B in the sentences shows the presentation of multimedia interactive controllers.

Another important feature of the application is link relationship between controller modules. In this exemplary embodiment description is given to the LINK relationship between controllers of model, picture and price. When the user chooses a model from (Select the model) option menu, the corresponding picture and price of this model display at the same time. The CONTAIN relationship is disclosed in the motor collection and the models. If the collection of a certain motor is selected, all models of the motorcycle collection can be seen in the following option menu. All other models, which do not belong to this motorcycle collection, can not be seen. The RXML and the multimedia controller items are shown in the following XML document.

//the relational XML describe the relation between the
controllers
//the link relation
//attention C
<relation name=“relation 1”

<rxml: link>

<item attr=xfm: optionmenu ref=“model”>

<item attr=xfm: optionmenu model= “picture”

ref=“picture”>
<item attr=xfm: optionmenu ref= “price”>

</rxml: link>
</rxml: instant attr=normal>
</rxml: instant >

</relation>
//the contain relation
//attention D
<relation name=“relation 2”>

<rxml: contain>

<item attr=xfm: optionmenu ref=“moto”>
<containitem attr=xfm: optionmenu ref=“model”>

</rxml: contain>
</rxml: instant>

<item attr=xfm: item>Buggy</ item >
< containitem attr= xfm: item>Normal</ containitem >
< containitem attr= xfm: item>Model A</ containitem >
< containitem attr= xfm: item>Model B</ containitem >

</rxml: instant >

</relation>

According to an embodiment of the present invention a MMS service middleware is designed for MMS service providers to push MMS messages to users, and process incoming MMS messages, for example from the MMS terminal, to provide value-added service. The sender of the message is authenticated by the authentication module, which uses the user management database to verify user. After the authentication, the message is parsed by a message parser. Then the message is passed on to the right message service for process via the service interface. When a service initiates a message, the message is verified by a push trigger and sent out via the MMS interface.

The user interface defines the size, air, position, show time, movement of interface parameters, and the interface defines how to add the data instances into the presentation of the pages. The user interface may be implemented with UI-wares. An UI-ware means a form, which can be displayed and interactive in a predefined mode. See FIG. 11 for a reference, the UI-ware shown can be an independent item such as text, picture, video, audio, or a form controller like button, check box, list box, radio button, option menu, input field. The items of the form controller can be text, picture, video or audio. The form controllers have the same interactive capabilities as normal HTML Form controllers or Xforms controllers. In the implementation, the specification XForms can he used here. The independent items have no redefined interactive capability, but their interactive capability can be added in relations/actions part. An interface parameter can be shown in diverse UI-wares. For example, an interface parameter with multiple-choice capability can be shown in a check box or a list box, because they are all multiple-choice controllers. The more important is, a data model can be rendered into diverse presentation for diverse MMS devices.

The interactive capabilities of interface parameters describes whether an interface can be display/play/edit/select, and whether it is of a single-choice or multiple choice. For example, a message can have two kinds of interface parameters. One is text, which can be input and modified. Another is an audio array. User can select one item from the array at a time and each of the items can be played.

Up to now, the interactive approach for multimedia message, user terminal and communication system have been described in details by means of exemplary embodiments. It should be understood that the present invention is not limited to the illustrated embodiment examples, on the basis of the description of the embodiments of the present invention, those skilled in the art can make various modifications and improvements according to the resent invention, without departure from the spirit and scope of the present invention.

1. An interactive method for multimedia message services comprising the steps of: receiving a multimedia message from a server; generating a page displaying or playing the multimedia message at a user terminal, wherein one or more control elements are embedded into the displayed or played multimedia message and the relationship between said control elements is defined; responsive to the operation of one or more of said control elements, triggering an action event to automatically generate a response message to request a service from the server; and sending the response message to the server.

2. The interactive method according to claim 1, wherein the step of generating the page for displaying or playing a multimedia message further includes: parsing the received multimedia message to obtain the presentation structure of said multimedia message; and generating a data model used in the page for displaying or playing said multimedia message based on said multimedia message presentation structure.

3. The method according to claim 1, further comprising the step of triggering an action event to modify the content of said multimedia message; and in response to the operation of said control elements, displaying or playing said modified content of said multimedia message.

4. The method according to claim 1, wherein said relationship includes at least one of a LINK relationship and a CONTAIN relationship.

5. The method according to claim 1, further comprising the steps of: parsing the received multimedia message to obtain an action list of related action rules; listening in the triggered action events based on said action list.

6. The method according to claim 1, wherein said multimedia message is composed in the language forms of XForms, XML, SMIL, XHTML or HTML.

7. The method according to claim 1, wherein a control element includes one of a submit button, a selective button, a radio button, a check box, a text, a text field, a list box, an option menu.

8. A user terminal for a multimedia message service comprising: a device for receiving a multimedia message from a server; a device for generating a page for displaying or playing said multimedia message; a device for embedding one or more control elements, between which relationships are defined, into said displayed or played multimedia message; and a device for triggering at least one action event in response to an operation of said one or more control elements, the action event automatically generating a response message to request a service from the server.

9. The user terminal according to claim 8, wherein the device for generating the page for displaying or playing a multimedia message further includes: a device for parsing the received multimedia message to obtain the presentation structure of said multimedia message; and a device for generating a data model used in the page for displaying or playing said multimedia messages based on said multimedia message presentation structure.

10. The user terminal according to claim 8, wherein when said triggered action event is to modify the content of said multimedia message, in response to the operation of said controller, said means for triggering action event and for performing corresponding action displays or plays said modified content of said multimedia message.

11. The user terminal according to claim 8, wherein said relationship includes at least one of a LINK relationship and a CONTAIN relationship.

12. The user terminal according to claim 8, further comprising a device for parsing the received multimedia message to obtain an action list of related action rules; and a device for listening in the triggered action events based on said action list.

13. The user terminal according to claim 8, further comprising forming a multimedia message service communication system comprising: at least one user terminal; and at least one server for sending a multimedia message to said at least one user terminal.

14. A computer program for running on a user terminal within a multimedia communication system, wherein said communication system comprises at least one user terminal, and at least one server for sending a multimedia message to said at least one user terminal, said computer program comprising instructions for carrying out all the steps of the method of claim 1 when the computer program is executed on one user terminal.

15. A program storage device readable by machine, tangibly embodying a program of instructions executable by the machine to perform method steps for multimedia message services, said method steps comprising the steps of:
receiving a multimedia message from a server;
generating a page displaying or playing the multimedia message at a user terminal, wherein one or more control elements are embedded into the displayed or played multimedia message and the relationship between said control elements is defined;
responsive to the operation of one or more of said control elements, triggering an action event to automatically generate a response message to request a service from the server; and
sending the response message to the server.

16. A program storage device readable by machine as recited in claim 15, wherein the step of generating the page for displaying or playing a multimedia message further includes: parsing the received multimedia message to obtain the presentation structure of said multimedia message; and generating a data model used in the page for displaying or playing said multimedia message based on said multimedia message presentation structure.

17. A program storage device readable by machine as recited in claim 15, said method steps further comprising the step of triggering an action event to modify the content of said multimedia message; and in response to the operation of said control elements, displaying or playing said modified content of said multimedia message.

18. An article of manufacture comprising a computer usable medium having computer readable program code means embodied therein for causing steps for multimedia message services, the computer readable program code means in said article of manufacture comprising computer readable program code means for causing a computer to effect the steps of claim 1.

19. A program storage device readable by machine, tangibly embodying a program of instructions executable by the machine to perform method steps for multimedia message services, said method steps comprising the steps of claim 1

20. A program storage device readable by machine as recited in claim 19, said method steps further comprising the steps of:
triggering an action event to modify the content of said multimedia message; and in response to the operation of said control elements, displaying or playing said modified content of said multimedia message;
parsing the received multimedia message to obtain an action list of related action rules;
listening in the triggered action events based on said action list, and
parsing the received multimedia message to obtain an action list of related action rules; and
listening in the triggered action events based on said action list, and
wherein the step of generating the page for displaying or playing a multimedia message further includes:
parsing the received multimedia message to obtain the presentation structure of said multimedia message;
generating a data model used in the page for displaying or playing said multimedia message based on said multimedia message presentation structure.
